(19) United States
(12) Patent Application Publication
(10) Pub. No.: US 2012/0278154 A1
(43) Pub. Date: Nov. 1, 2012

(54) MARKETING INVENTORY BASED ON SPOILAGE

(75) Inventors: DANNY LANGE, Sammamish, WA (US); MILLER THOMAS ABEL, Mercer Island, WA (US); MATTHEW GRAHAM DYOR, Bellevue, WA (US); JOHN C. SHAFER, Los Altos, CA (US); STELIOS PAPARIZOS, San Jose, CA (US); JOSEPH FUTTY, Sammamish, WA (US); SREENIVAS GOLLAPUDI, Cupertino, CA (US)

(73) Assignee: MICROSOFT CORPORATION, REDMOND, WA (US)

(21) Appl. No.: 13/096,323

(22) Filed: Apr. 28, 2011

(51) Int. Cl. G06Q 30/00

(52) U.S. Cl. 705/14.24; 705/14.58

(57) ABSTRACT

An inventory marketing system operates to identify and market inventory items that are likely to spoil. Initially, inventory items that have a particular likelihood of spoilage may be identified. Customers to target with offers for the inventory items may be identified based on the customers' current location or expected location near a spoilage time for the inventory items. Offers for the inventory items may be provided to the targeted customers, and purchases of the inventory items by customers may be facilitated.

### BACKGROUND

Merchants often have “inventory” that if unsold by a certain time becomes spoiled because the inventory can no longer be sold to customers after that time. While this may often be the case for some goods such as produce, this is also the case in the service industry. For instance, the inventory for a hair salon may be the appointment times at which customers may be serviced. If a customer isn't scheduled for a particular appointment time and a walk-in doesn't come in at that time, the appointment time becomes spoiled in the sense that a customer is not serviced to generate revenue for that appointment time. Accordingly, merchants attempt to avoid letting inventory go spoiled as the spoiled inventory results in loss of revenue to the merchants.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to an inventory marketing system that may identify and market inventory items that are likely to spoil. Initially, inventory items being offered by merchants and that are likely to spoil may be identified. Customers who are currently within or expected to be within a vicinity of the inventory items near a spoilage time for the inventory items may also identified. Offers for the inventory items may then be provided to those customers, and transactions for the customers to purchase the inventory items may be facilitated.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram that illustrates an environment for marketing inventory items based on spoilage in accordance with an embodiment of the present invention;

FIG. 3 is a flow diagram showing a method for identifying an inventory item likely to spoil and marketing the inventory item to targeted customers in accordance with an embodiment of the present invention;

FIG. 4 is a flow diagram showing a method for receiving inventory information manually entered by a merchant in accordance with an embodiment of the present invention;

FIG. 5 is a flow diagram showing a method for automatically identifying an inventory item to market in accordance with an embodiment of the present invention;

FIG. 6 is a flow diagram showing a method for using historical information to identify likelihood of spoilage of inventory and using the information for purposes of marketing inventory in accordance with an embodiment of the present invention;

FIG. 7 is a flow diagram showing a method for bundling multiple inventory items together and offering them as a single package via the inventory marketing system in accordance with an embodiment of the present invention;

FIG. 8 is a flow diagram showing a method for targeting customers based on time and location in accordance with an embodiment of the present invention;

FIG. 9 is a flow diagram showing a method for targeting customers using customer profile information in accordance with an embodiment of the present invention;

FIG. 10 is a flow diagram showing a method for facilitating the purchase of an inventory item by a customer in accordance with an embodiment of the present invention;

FIG. 11 is a flow diagram showing a method for employing a declining purchase price for marketing an inventory item in accordance with an embodiment of the present invention;

FIG. 12 is a flow diagram showing a method for allowing customers to bid on an inventory item in accordance with an embodiment of the present invention; and

FIG. 13 is a flow diagram showing a method for notifying other users when an inventory item has been purchased in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to identifying merchants' inventory items that are likely to spoil and marketing the inventory items to targeted customers. The inventory items are identified at some point as having a higher likelihood of spoilage such that they are expected to spoil. The inventory items likely to spoil and marketed may be manually identified by merchants or automatically identified by analyzing merchants' inventory management systems. A likelihood of spoilage for inventory items may be determined based on various factors, such as the proximity to the time at which the inventory items spoil and historical information regarding sales of merchants' inventory. The decision to market the inventory items and/or a price at which the inventory items will be offered to customers may be set based on the likelihood of spoilage for the items. In some embodiments, the inventory items marketed by the inventory management system have a particularly limited availability based on location and time and the time of availability of the inventory items may correspond with the spoilage time of the items.

Customers to receive offers for inventory items may be targeted in a number of ways. For instance, customers may be targeted based on location and time. In various embodiments, customers who are currently located or predicted to be located within a vicinity of an inventory item at a time near the spoilage time of the inventory item may be targeted. The location information may be based on mobile device GPS information, social networking “check-in” information, and/or other location information. Other factors, such as demographic information, loyalty information, interests, preferences, purchase history, internet browsing history, and search history, may also be used for targeting purposes.

Offers for inventory items may be delivered to targeted customers. The customers may review the information and decide whether to purchase the inventory items. Because the inventory items are likely to spoil, the merchants may be offering the inventory items to the customers at reduced prices, thereby incentivizing the customers to purchase the items. Additionally, because customers are targeted based on a current location or expected location being within a vicinity of the inventory items, the customers may be more likely to purchase the inventory items. In some embodiments, the inventory marketing system may facilitate customer purchases of the inventory items using a number of different approaches, as described herein.

Accordingly, in one aspect, an embodiment of the present invention is directed to one or more computer storage media storing computer-useable instructions that, when used by one or more computing devices, cause the one or more computing devices to perform a method. The method includes identifying an inventory item that is likely to spoil. The method also includes identifying a location of a customer. The method further includes determining to market the inventory item to the customer based on the location of the customer relative to a location of the inventory item. The method still further includes providing an offer for the inventory item to the customer.

In another embodiment, an aspect of the invention is directed to one or more computer storage media storing computer-useable instructions that, when used by one or more computing devices, cause the one or more computing devices to perform a method. The method includes identifying an inventory item that is likely to spoil. The method also includes determining a location of the inventory item and a spoilage time indicative of when the inventory item will spoil if unsold. The method further includes identifying a customer within a vicinity of the inventory item near the spoilage time for the inventory item by accessing location information for the customer provided via a mobile device of the customer. The method also includes providing an offer for the inventory item to the mobile device of the customer for display to the customer. The method still further includes facilitating a purchase of the inventory item by the customer.

A further embodiment of the present invention is directed to an inventory marketing system including one or more computing devices having one or more processors and one or more computer storage media. The inventory marketing system includes an inventory identification component, a customer targeting component, an offer delivery component, and a transaction component. The inventory identification component identifies inventory items that are likely to spoil and identifies a location of each inventory item and a spoilage time for each inventory item. The customer targeting component identifies customers to offer each inventory item, wherein the customers identified for a given inventory item are identified as being located within a vicinity of the given inventory near the spoilage time for the given inventory item. The offer delivery component delivers offers for each inventory item to customers identified by the customer targeting component for each inventory item. The transaction component facilitates purchases of the inventory items.

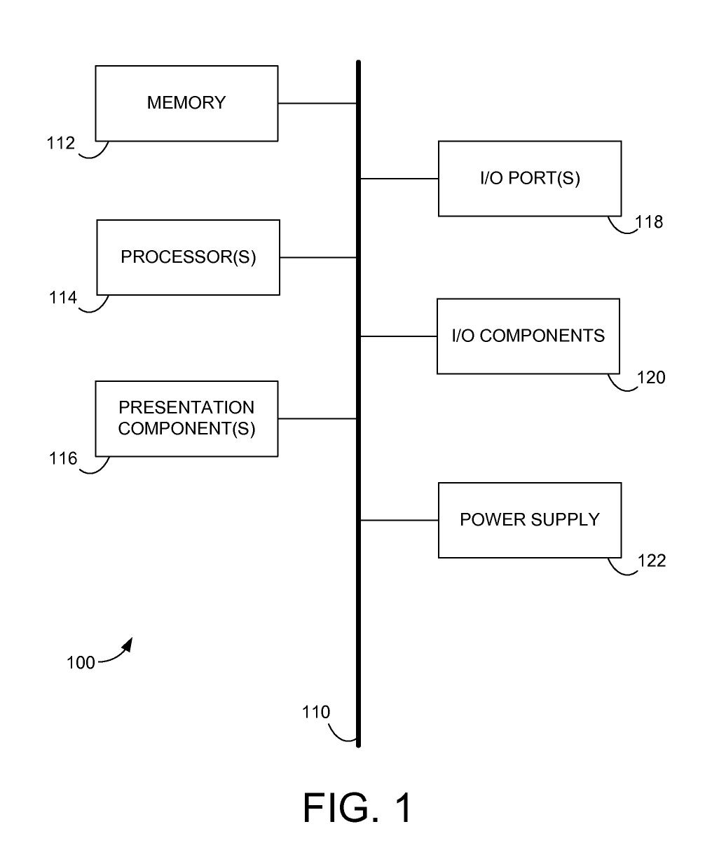

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

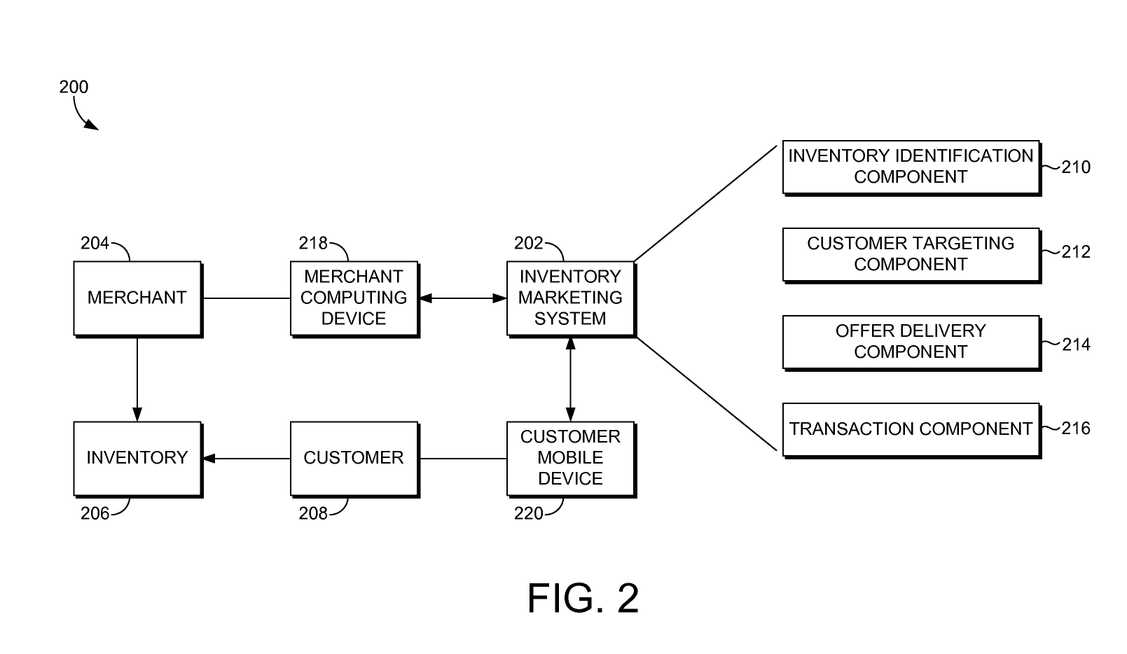

Referring now to FIG. 2, a block diagram is presented that illustrates an environment 200 for marketing inventory items based on spoilage in accordance with an embodiment of the present invention. As shown in FIG. 2, an inventory marketing system 202 communicates with merchants, such as merchant 204, to identify inventory items, such as inventory item 206, that are expected to spoil and markets the inventory items to targeted customers, such as the customer 208. Customers may select to purchase the inventory items, and the inventory marketing system 202 may operate to facilitate the transactions. Although only a single merchant 204 and single customer 208 are shown in FIG. 2, it should be understood that inventory from multiple merchants may be marketed to any number of customers in accordance with various embodiments of the present invention.

Each inventory item identified and marketed by the inventory marketing system 202 has some spoilage time such that if the inventory is not sold by that time, the inventory will spoil and can no longer be sold. For instance, an inventory item could be a product that has a particular shelf life and cannot be sold beyond some point in time. As another example, an inventory item may be some service with an associated appointment or reservation time, such as a hair appointment or table reservation at a restaurant. As such, the inventory items marketed by the inventory marketing system 202 may include products and/or services.

Embodiments of the present invention are intended to identify inventory items that are likely to spoil and to market those inventory items to targeted customers who are known to be or predicted to be in the vicinity of the inventory items near the spoilage time for the items. As such, an inventory item identified for marketing via the inventory marketing system 202 has an associated location at which it is available and a spoilage time, which corresponds with a time with which the merchant can no longer sell the inventory item. Although the location of the inventory item is typically static, in some instances, the location of an inventory item (e.g., a taxi) may change and the current location of the item may need to be identified. Additionally, the spoilage time may correspond with a time at which an item becomes available to be consumed by a customer; although it should be noted that in some instances, the spoilage time could occur before or after a time corresponding with an inventory item. For instance, if an appointment slot for a service item starts at 11:00 am, the spoilage time could be set at 11:05 am since a customer arriving at 11:05 am could still be serviced in that appointment slot.

In some instances, the inventory marketing system 202 may be specifically directed to identifying and marketing inventory that has a particularly limited availability or scarcity based on time and location. For instance, an appointment time slot may only be available at a particular location at a limited time period (e.g., from 11:00 am to 11:30 am). In other words, the inventory item may only be available to be purchased and consumed by a customer at a very distinct and limited time. This limited availability also closely corresponds with the spoilage time for the inventory item. For instance, an appointment slot from 11:00 am to 11:30 am has a limited availability corresponding with that time period and a spoilage time that corresponds with that availability time. In particular, the appointment slot will spoil if not sold by a time around the 11:00 am start time. This is different from other forms of inventory that may be available over a longer time period, such as products which may be sold at any time until the products spoil.

The inventory marketing system 202 may comprise one or more computing devices, such as the computing device 100 described above, that operate to provide the functions described herein. For instance, the inventory marketing system 202 may include a server, a server farm, cloud computing service, or other distributed computing environment provided by a system provider. As shown in FIG. 2, the inventory marketing system 202 may generally include, among other components not shown, an inventory identification component 210, a customer targeting component 212, an offer delivery component 214, and a transaction component 216.

The inventory identification component 210 may be configured to identify inventory items that are likely to spoil and thus could be marketed to customers. The inventory identification component 210 may identify such inventory items in a number of different ways in accordance with various embodiments of the present invention. In some embodiments, the inventory identification component 210 may provide an interface to merchants that merchants may access to manually enter details of inventory items to be marketed by the system 202. For instance, FIG. 2 illustrates a merchant computing device 218 that may be employed by the merchant 204 to enter details of the inventory item 206 to allow the inventory marketing system 202 to market the inventory 206 to customers, such as the customer 208. The merchant 204 may specify details of the inventory item 206, including, for instance, a description of the inventory 206, its location, a time at which the inventory will spoil, and pricing information.

In another embodiment, the merchant computing device 218 may comprise an inventory tracking system that stores information regarding the merchant's entire inventory. For instance, in the context of a merchant who sells products, the inventory tracking system may track products within the merchant's inventory. In the context of a merchant who provides services, the inventory tracking system may track appointments or reservations, including booked and open times. In such embodiments, inventory identification component 210 may receive information from or otherwise communicate with the inventory tracking system provided by the merchant computing device 218. In some instances, the merchant's inventory tracking system may identify inventory items to market and provide information for the identified inventory items to the inventory identification component 210. In other instances, the inventory identification component 210 may review information from the inventory tracking system and identify inventory items to market. Additionally, in some embodiments, identified inventory items may be automatically identified and marketed to customers by the inventory marketing system 202; while in other embodiments, an indication may be provided to merchants that inventory items have been automatically identified, and the merchant may choose whether to market the identified inventory items to customers and/or may choose to adjust information such as the offer prices. Any and all such variations are contemplated to be within the scope of embodiments of the present invention.

The determination that an inventory item is likely to spoil and should be marketed by the inventory market system 202 may be based on a number of factors. For instance, the determination may be based on the proximity to the spoilage time for an inventory item. By way of example, it may be detected that the appointment time for an open time slot is less than an hour away. Because the appointment time slot has not yet been filled at that time, this may be an indication that the appointment time slot is likely to spoil and therefore should be marketed via the inventory marketing system 202, potentially at a reduced price to attract customers.

The determination of a likelihood of spoilage may also be used to set an offer price for an inventory item. In particular, the more likely an item is to spoil, the less money a merchant may be willing to accept to entice a customer to purchase the inventory item. Of course, there may be a minimum price below which a merchant may not be willing to sell an inventory item.

In some embodiments, historical information may be employed to determine whether inventory is expected to spoil and used in identifying inventory items to market via the inventory marketing system 202, as well as helping to set an offer price for inventory items. The historical information may include purchase information, including what inventories have sold and when, and may also include seasonality market conditions. By way of specific example, a hair salon may typically get a large number of walk-ins on Friday afternoons such that appointments on Friday afternoons are not expected to spoil, while very few walk-ins come in on Monday afternoons such that the appointments then are more likely to spoil.

This historical information analysis may be used as a form of an alert to merchants when the merchants manually enter inventory items to market. For instance, when a merchant manually enters an inventory item, analysis of historical information for the merchant's inventory may indicate that the inventory item is not likely to spoil but is likely to sell, and an indication may be provided to the merchant. This may allow the merchant to decide not to market the item via the inventory marketing system 202 or may allow the merchant to appropriately price the inventory item based on the likelihood of spoilage. For instance, the merchant may decide to offer an inventory item at a higher price if the item is less likely to spoil, while the merchant may decide to offer an inventory item at a lower price if the item is more likely to spoil.

The historical information analysis may also be used when an analysis of a merchant's inventory is performed to automatically identify inventory items to market via the inventory marketing system 202. In particular, historical information may provide an indication of a likelihood of spoilage, which may be taken into consideration during the analysis to identify inventory items. The more likely an item will spoil, the more likely the inventory item will be identified for marketing to customers. Additionally, the likelihood of spoilage determined by analysis of historical information may be used to automatically determine pricing for inventory items offered by the inventory marketing system 202. If particular, the more likely the item is to spoil, the lower the offer price may be set.

In further embodiments, multiple scarce inventory items could be bundled together as an offer based on various factors, including the type of inventory items, the location of the inventory items, and the time the inventory items will spoil. The inventory items may be provided by a single merchant or may be provided by different merchants. For instance, suppose that a restaurant has an open reservation time. Additionally, a theater in the vicinity of the restaurant has seats available for a show time that would work well with the reservation time. Accordingly, it may be determined that these types of inventory items complement one another, they are located near one another, and their availability times are compatible. Therefore, the inventory items may be bundled into a single offer that may be provided to customers.

The customer targeting component 212 operates to identify customers to which to send offers for inventory items. In embodiments, customer targeting may be location-based in that customers are selected who are currently or predicted to be within a certain distance of the location of an inventory item within a certain time period before spoliation occurs. As such, the customer targeting component 212 may access location information for users to determine which users to target for specific inventory items. To address privacy concerns, customers may need to provide the inventory marketing system 202 permission to track their location information.

The location information for customers may be obtained from any of a number of different sources. The following provide non-limiting examples, as location information may be obtained in any of a variety of different ways in accordance with embodiments of the present invention. By way of example only and not limitation, customer location information may be based on GPS information determined using customers' mobile devices, such as the customer mobile device 220 for the customer 208. For instance, the customer targeting component 212 may receive GPS information from the customers' mobile devices or from a server that is able to access the information.

In some embodiments, location information may be determined based on “check-in” information from social networking sites, such as the FOURSQUARE social networking site. For instance, when users “check-in” at establishments using their mobile devices or other methods, information regarding where the users are located may be provided to the customer targeting component 212. Users may also be able to indicate their current or future locations using, for instance, an application that allows the users to manually indicate the location information.

In some embodiments, the customer targeting component 212 targets customers at a time near the spoilage time by identifying customers who are at that time within a vicinity of an inventory item. As such, it can be expected that the customers would still be in the vicinity of the inventory time when the inventory item is available. For instance, suppose a hair salon at a shopping area has an open appointment at 2:30 pm and the system 202 intends to target customers who have checked in via the FOURSQUARE social network site to other establishments in the shopping area. It likely would not make sense to identify customers at the shopping area at 10:00 am that morning since those customers will likely no longer be shopping in that area at the 2:30 pm appointment time. However, it may be preferable to identify customers at the shopping area at 2:00 pm since those customers are likely to still be in the shopping area at 2:30 pm and therefore more likely to take the appointment time. As such, the inventory marketing system 202 may identify and provide offers to customers who have checked in via the FOURSQUARE social network site to other establishments within the same shopping area as the hair salon within a certain time period before the 2:30 appointment that is relatively close in time to the 2:30 appointment.

In other embodiments, the customer targeting component 212 may target customers at an earlier time further out from the spoilage time for an inventory item by predicting the location of the customers around the spoilage time. For instance, historical location information for customers may be tracked to identify location patterns for the customers. Based on those location patterns, future locations of customers may be predicted, and customers may be targeted based on predicted locations. For instance, in the example above in which a hair appointment time is available at 2:30 pm, the merchant may wish to target customers earlier in the day. By analyzing customers' historical location information, the customer targeting component 212 may be able to predict customers who will be in the vicinity of the hair salon around 2:30 pm and target those customers.

In some embodiments, the customer targeting component 212 may estimate a time that it would take a customer to reach the location of an inventory item when determining whether offers for the inventory item should be targeted to the customer. This may include taking into account information, such as real-time traffic information, that allows for estimating whether the customer could get to the location of the inventory item before it spoils. In some embodiments, the information may be used to determine when to send offers to customers.

In other embodiments, the customer targeting component 212 may determine a “relocation energy” when determining whether to target a customer with a particular inventory item offer. The “relocation energy” represents an effort required for a customer to get from the customer's current location to a location of the inventory item. For instance, suppose a customer is located across a busy street from the location of an inventory item. Although the customer may be physically close to the inventory item, it may be difficult for the customer to cross the street to get to the location of the inventory item. It may make more sense to instead target customers who may be bit further from the inventory item but on the same side of the street, as it may be easier for those customers to get to the inventory item. In further embodiments, “relocation energy” may be used when selecting from multiple offers to send to a particular customer. For instance, if offers are available from two hair salons for open appointments at a particular time, a customer may be targeted for one of those offers based on the relocation energy required for the customer to reach that hair salon being less than that required for the other hair salon.

Other factors may also be employed when identifying customers to target offers for particular inventory items. In some embodiments, customers may sign up to receive offers and may indicate specific offer types the customers would like to receive. As such, offers for a particular inventory item may be targeted to customers who have indicated interest in that type of inventory. In some embodiments, user preferences and interests may be determined from other sources, such as a customer's purchase history, web search history, web browsing history, demographic information, or other available information that may partially define the customer. Offers may then be targeted to customers having certain traits, preferences, and/or interests, and therefore, may be more likely to purchase the inventory items marketed by the offers. In further embodiments, offers may be targeted to customers using some loyalty basis. For instance, only loyal customers for a given establishment may be eligible to receive offers for inventory items from that establishment.

After inventory items and targeted customers have been identified, the offer delivery component 214 operates to deliver offers for the inventory items to the targeted customers. Offers for inventory items may be delivered to customers using any of a number of different methods. The offers may be delivered to customers' mobile devices, such as the customer mobile device 220 of the customer 208, or other type of computing device. In some embodiments, the offers may be feed-based using, for instance, RSS feeds, TWITTER feeds, or FACEBOOK feeds. In some embodiments, customers may download and install on their mobile devices an application that is dedicated to managing user accounts for the inventory marketing system, and offers may be delivered to the customers via the application. In some embodiments, the offers may be provided via an application-agnostic notice presented on the customers' mobile devices such that the offers are presented by the mobile devices regardless of the customers' context on the devices. In other words, an automatic pop-up would be provided on the customers mobile devices when offers are received regardless of the current use state of the device. In further embodiments, offers may be provided in response to user actions showing potential interest in an inventory item. For instance, customers may submit a search query related to the inventory item, and an offer may provided as an advertisement as part of the search results.

In some embodiments, the offer delivery component 214 may send out offers to customers in different waves based on various factors. For instance, an offer for a particular inventory item may initially be sent to loyal customers in a first wave to provide those loyal customers with the first opportunity to purchase the item. Additional offers may then subsequently be sent out to other customers in a second wave if the inventory item is not purchased.

The transaction component 216 operates to facilitate customer purchases of inventory items offered by the inventory marketing system 202. In some embodiments, customers may be required to pre-purchase inventory items in response to offers. For instance, customers' mobile devices may include an application dedicated to facilitating advertising of inventory item offers and customer purchases of items. When a customer views an offer via the application, the customer may select to purchase the offered inventory item using the application, which communicates the selection to the inventory marketing system, and the transaction component 216 may facilitate the purchase. Other methods for allowing customers to purchase inventory items offered by the inventory marketing system 202 may also employed.

In some embodiments, an inventory item offer may include an offer price, and a first customer to respond to the offer can purchase the inventory item at the offered price. In some embodiments, the offer price for an inventory item may be static, while in other embodiments, the offer price may be set to continue to decline as the spoilage time for the item approaches. This price decrease may continue until a minimum price, which may be set by the merchant, is reached. For instance, the offer price displayed via an application on customers' mobile devices may be updated by reducing the offer price over time as the spoliation time approaches.

In further embodiments, an auction process could be employed in which customers may offer different bid prices for an inventory item with the highest bid wining the opportunity to purchase the inventory item. The auction may include a bid period in which bids are accepted. In some cases, a floor price may be set on the bidding and/or the merchant may decide whether to accept or reject the highest bid. Additionally, in some embodiments, the current highest bid price may be advertised to customers to allow customers to submit higher bids, and customers may submit multiple bids during the bid period.

An auction process could also be used in conjunction with a fixed price approach. For instance, an offer may include an offer price at which an inventory item may be purchased as well as invite bid offers from customers. This may include a type of “pre-sale” in which customers may select to purchase an item at a full price or other fixed price. A customer may select to purchase the item at that price or may submit a bid price that is lower than the offer price. If no customer purchases the inventory item at the offered price and multiple bids are received, the customer with the highest bid price purchases the inventory item at that bid price.

When inventory items are sold, confirmations may be provided to the merchants offering the items that the inventory items have been sold. The confirmations may include information, such as the name of the customers who purchased the items. Additionally, the customers purchasing the inventory items may receive confirmation of the purchases, directions to the location of the inventory items, and/or other information. Further, after inventory items have been sold, a notice may be sent to the other customers who received the original offer indicating that the inventory items have been sold.

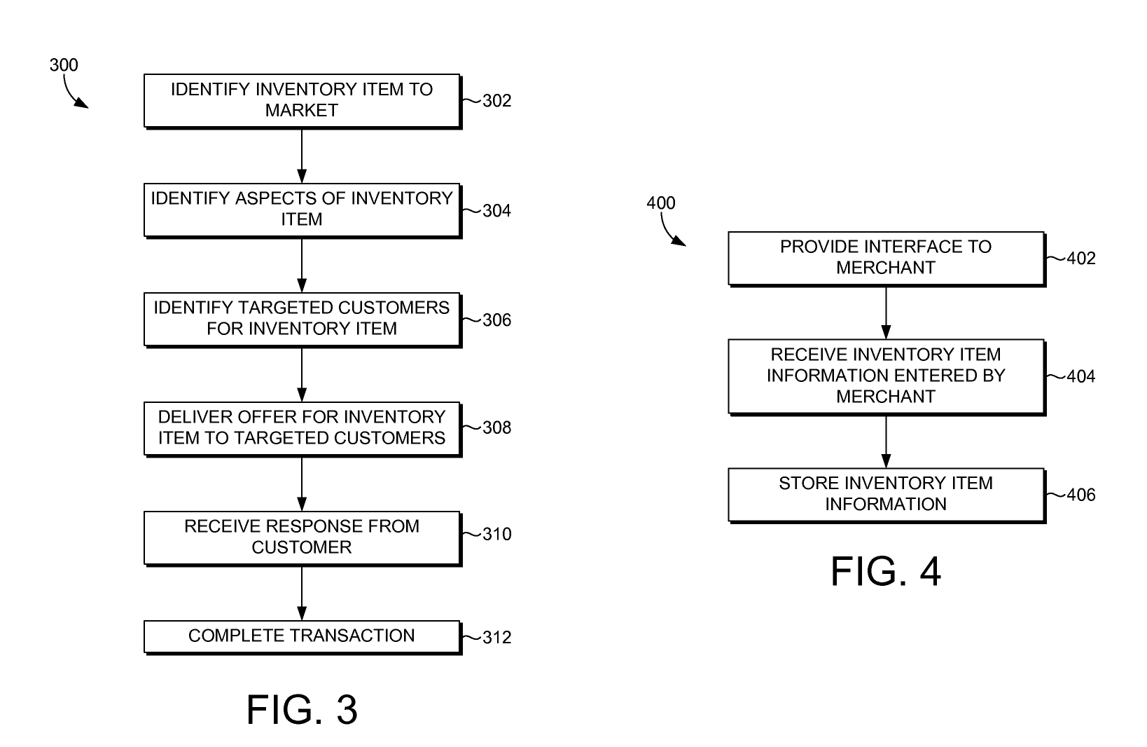

Referring now to FIG. 3, a flow diagram is provided that illustrates an overall method 300 for identifying an inventory item likely to spoil and marketing the inventory item to targeted customers in accordance with an embodiment of the present invention. Initially, as shown at block 302, an inventory item to market is identified. The inventory item may be identified in a number of different ways as described herein, including having the inventory item manually identified by a merchant or having the inventory item automatically identified by analyzing the merchant's inventory. Generally, the inventory item is identified as an item that is likely to spoil. In some embodiments, the identification of the inventory item may be directed to not only identifying that the inventory item is likely to spoil but also identifying that the inventory item has a particularly limited availability based on its location and a distinct time at which the item is actually available to customers (e.g., an appointment or reservation time slot, sporting or other type of event).

Aspects of the inventory item used to market the item are also identified, as shown at block 304. These aspects may include, for instance, a description of the inventory item, a location of the inventory item, and a spoilage time for the inventory item. Customers to target offers for the inventory item are identified, as shown at block 306. Generally, the customers may be identified based on their current or expected location with respect to the location of the inventory item near the spoilage time for the inventory item. Additional factors, such as demographic information, interests, preferences, and loyalty information may also be employed to identify customers that are likely to purchase the inventory item. An offer for the inventory item is sent to each of the identified customers, as shown at block 308. A response to purchase the inventory item is received from a customer, as shown at block 310, and a transaction for the inventory item may be completed, as shown at block 312.

As indicated previously, inventory that is likely to spoil and may be marketed to customers may be identified in a number of ways. Turning to FIG. 4, a flow diagram is provided that illustrates a method 400 for receiving inventory information manually entered by a merchant in accordance with an embodiment of the present invention. As shown at block 402, an interface is provided to allow the merchant to enter details of an inventory item. Details of the inventory item are received via the interface at block 404. These details may include, among other things, a description of the inventory item, a location of the inventory item, a time at which the inventory item will spoil, pricing information, and customer targeting information. The inventory information received from the merchant is stored at block 406 such that it may be used to target offers for the inventory item to customers.

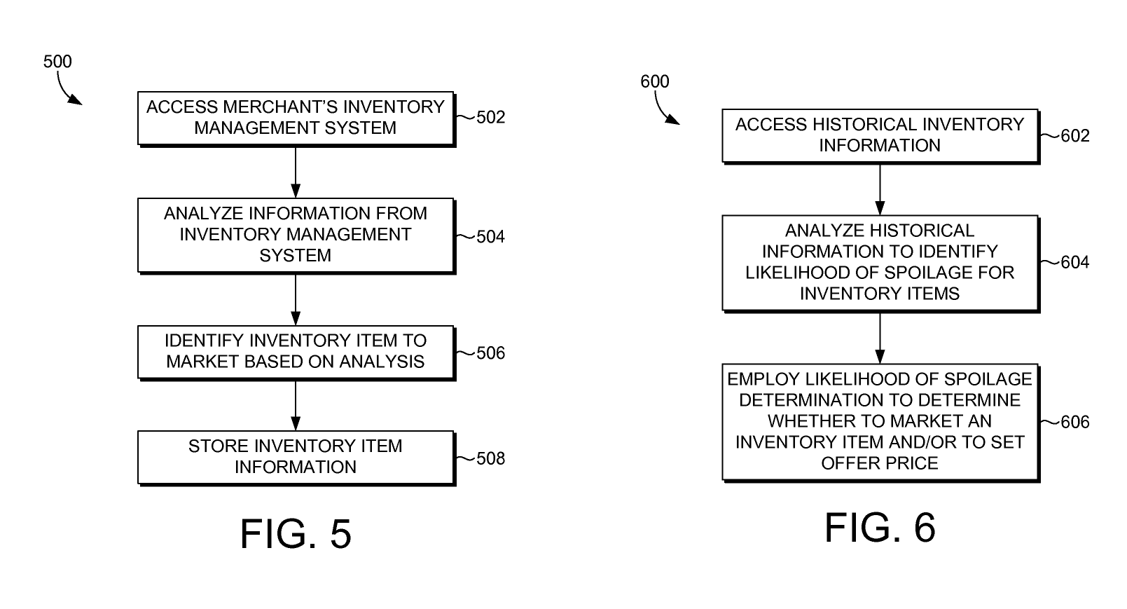

Referring next to FIG. 5, a flow diagram is provided that illustrates a method 500 for automatically identifying an inventory item to market in accordance with an embodiment of the present invention. As shown at block 502, a merchant's inventory management system is accessed. The inventory management system may be any system that manages information regarding the merchant's inventory. For a merchant selling products, this could include a system that tracks information regarding the merchant's product inventory. For a merchant providing services, this could include a system that tracks customer appointment or reservations, including open and reserved times.

Information regarding the merchant's inventory is analyzed at block 504. Based on this analysis, an inventory item that is likely to spoil and may be advertised to customers via the inventory marketing system is identified, as shown at block 506. Information regarding the identified inventory item is stored at block 508 such that it may be used to target offers for the inventory item to customers. This may include, among other things, a description of the inventory item, a location of the inventory item, a time at which the inventory item will spoil, pricing information, and customer targeting information.

In some embodiments, historical information regarding sale of a merchant's inventory may be employed to assist in identifying inventory items to market to customers and/or to assist in setting offer prices for marketed inventory items. In particular, analysis of such historical information may provide an indication of likelihood of spoilage for inventory. This analysis could be used in both the manual and automatic approaches discussed above for identifying inventory items to market. With reference to FIG. 6, a flow diagram is provided that illustrates a method 600 for using historical information to identify likelihood of spoilage of inventory and using the information for purposes of marketing inventory in accordance with an embodiment of the present invention. As shown at block 602, historical inventory information for a merchant is accessed. This may include information regarding the sale of inventory, including, for instance, what inventory was sold and when the inventory was sold. In some embodiments, historical inventory information from similar merchants may be accessed in addition to or in lieu of information from the merchant. This information from similar merchants may provide a trend for the kind of goods or services offered by the merchants.

The historical information is analyzed at block 604 to identify likelihood of spoilage of items within the merchant's inventory. In some embodiments, patterns of what items sell and when the items sell may be identified from the historical information. These patterns may provide an indication of how likely certain items will spoil. For instance, a hair salon may typically get a large number of walk-ins on Friday afternoons, while very few walk-ins come in on Monday afternoons. Based on this pattern, it could be determined that appointments on Friday afternoons are not as likely to spoil as compared to appointments on Monday afternoons. When information is accessed from similar merchants, the information may be used to identify trends for the type of goods/services offered by the merchants to help determine the likelihood of spoilage for items of the merchant being currently evaluated.

As shown at block 606, the determined likelihood of spoilage may be used to determine whether to market the inventory item via the inventory marketing system and/or to determine an offer price for the item. In some embodiments, this may comprise providing the likelihood of spoilage information to the merchant and allowing the merchant to manually determine whether to market an item and/or set an offer price for the item. In other embodiments, this may comprise automatically analyzing the information to automatically determine whether to market the item and/or to automatically set an offer price for the item. For instance, the likelihood of spoilage determined by analyzing historical information may be used during the analysis at block 504 of FIG. 5.

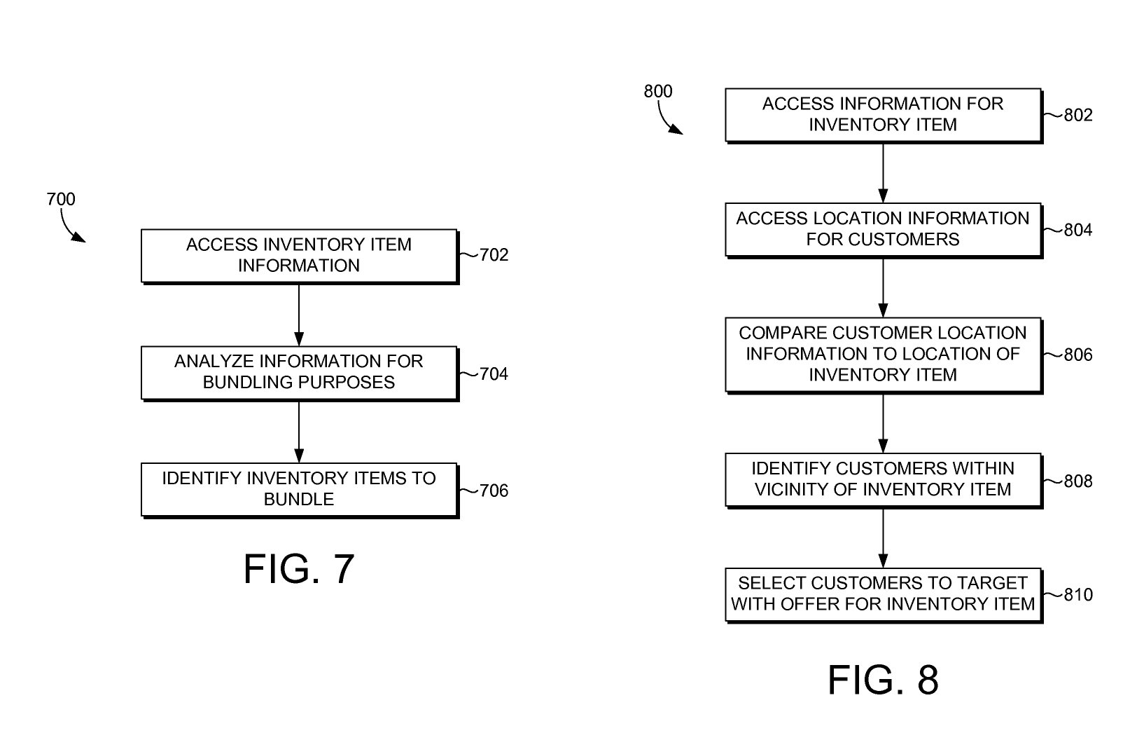

Turning next to FIG. 7, a flow diagram is provided that illustrates a method 700 for bundling multiple inventory items together and offering them as a single package via the inventory marketing system in accordance with an embodiment of the present invention. As shown at block 702, information regarding inventory items is accessed. This may include receiving information manually entered by merchants and/or accessing the information from merchants' inventory management systems. The information accessed for each inventory item may include, for instance, a description of the item, a location of the item, and a time the item will spoil.

The inventory item information is analyzed at block 704 to determine whether two or more inventory items may be bundled together. This may include identifying inventory items that complement one another by item type (e.g., dinner and theater tickets), that are located near one another, and that become available and/or spoil within a time period of one another that allows for bundling the items together. Based on this analysis, two or more inventory items are bundled together for marketing via the inventory marketing system, as shown at block 706.

After identifying inventory items to market, customers may be identified for targeting offers for the inventory items. Referring to FIG. 8, a flow diagram is provided that illustrates a method 800 for targeting customers based on time and location in accordance with an embodiment of the present invention. As shown at block 802, information regarding an inventory item is accessed, including the location of the item and a spoilage time for the item. At a certain point before the spoilage time (which may be merchant-defined or system-defined), location information for customers is accessed, as shown at block 804. The location information may correspond with customers' current location or customers' predicted location near the spoilage time for the inventory item. Customers' current location may be accessed near the spoilage time for the inventory item, while customers' predicted location may be accessed at a time well in advance of the spoilage time.

The location information for the customers is compared to the location of the inventory item, as shown at block 806. Based on this comparison, customers within a vicinity of the inventory item near the spoilage time are identified, as shown at block 808. This may include customers who are currently within a vicinity of the inventory item at a time near the spoilage time and/or customers who are expected to be within a vicinity of the inventory item at a time near the spoilage time. Customers to target an offer for the inventory item are then selected, as shown at block 810.

Identification of customers within the vicinity of the inventory item and the selection of customers to target may include an estimation of the time it would take for a customer to get from a current location to the location of the inventory item. This estimation may take into account real-time information available to the system, such as current traffic information, public transportation information, or other information that would assist in calculating a travel time for a customer. In some embodiments, a consideration of the “relocation energy” for the customer to get from a certain location to the location of the inventory item may also be a factor in targeting the customer.

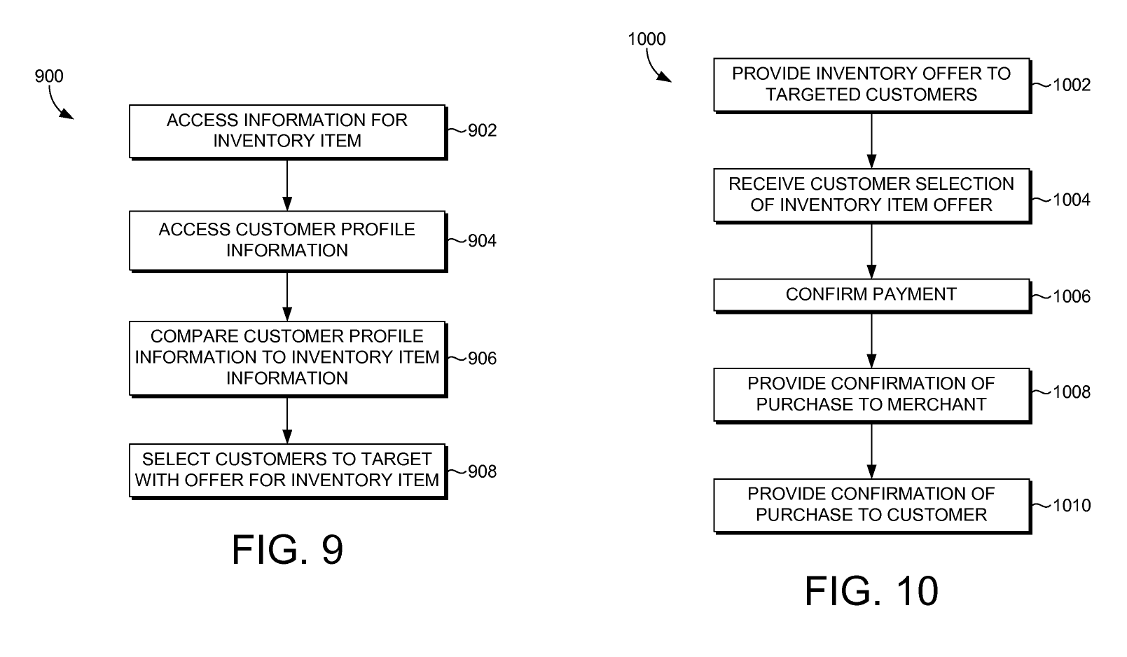

In some embodiments, other information regarding customers may be used when identifying customers to receive offers for particular inventory items. FIG. 9 illustrates a method 900 for targeting customers using customer profile information in accordance with an embodiment of the present invention. As shown at block 902, information for an inventory item is accessed. Additionally, customer profile information is accessed for a number of customers, as shown at block 904. The accessed customer profile information includes information that may partially define the customers and may be analyzed to identify customers that are eligible to receive an offer and/or likely to purchase the inventory item. By way of example only and not limitation, this information may include demographic information, loyalty information, interests, preferences, purchase history, internet browsing history, and search history.

The customer profile information is compared against the inventory item information at block 906. Based on the comparison, one or more customers are selected to target with an offer for the inventory item, as shown at block 908. In some embodiments, only certain customers, such as those who have been identified as loyal customers, may be eligible to receive an offer to purchase the inventory item, and the comparison may identify those customers. In other embodiments, the comparison is intended to identify customers who are more likely to purchase the inventory item. In particular, the profile may include preferences and other information regarding the customers that is useful in finding customers who are more likely to purchase an item such that offers for the item can be targeted to those customers. For instance, the profile information may indicate that a first person may need a haircut since that first person's last haircut was two months ago, while a second person likely does not need a haircut since that second person had a haircut last week. As such, even though both the first person and second person are within the vicinity of a hair salon near the time of an open appointment, the first person may be targeted for a haircut offer, while the second person may not be sent an offer based on this profile information.

After identifying an inventory item and targeted customers to which to market the inventory item, an offer for the inventory item may be delivered to the targeted customers. As discussed above, offers for inventory items may be delivered to customers in a number of different manners. The process may end there in some embodiments, as the inventory marketing system may be configured to simply identify and broadcast inventory item offers to customers. In other embodiments, however, the inventory marketing system may also facilitate completing a transaction in which a customer purchases the inventory item.

With reference to FIG. 10, a flow diagram is provided that illustrates a method 1000 for facilitating the purchase of an inventory item by a customer in accordance with an embodiment of the present invention. As shown at block 1002, an offer for a particular inventory item is provided to a number of customers. A selection to purchase the inventory item is received from a customer, as shown at block 1004. Additionally, the customer may be required to purchase the inventory item. As such, the inventory marketing system confirms payment by the customer, as shown at block 1006.

A confirmation of the customer purchase is provided to the merchant, as shown at block 1008, to let the merchant know that the inventory item has been sold. The confirmation may include information regarding the customer who purchased the inventory item, such as the customer's name. A confirmation is also provided to the customer at block 1010 to let the customer know that the inventory item has been purchased by the customer. The confirmation may include additional information, such as the location of the inventory item, an appointment/reservation time, directions, and other details.

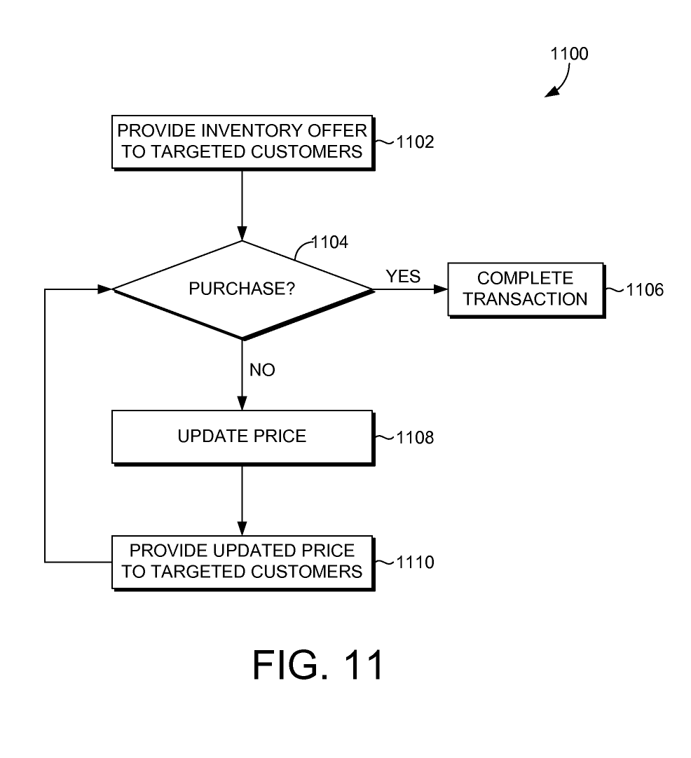

In some embodiments of the present invention, the purchase price may be set to decline as the spoilage time for an inventory item approaches and the inventory item remains unsold. Turning to FIG. 11, a flow diagram is provided that illustrates a method 1100 for employing a declining purchase price for marketing an inventory item in accordance with an embodiment of the present invention. As shown at block 1102, an offer for an inventory item is provided to a number of customers. The offer may include an initial price for the inventory item. A determination is made at block 1104 regarding whether a customer has purchased the inventory item. This determination may be made at a predetermined time, such as a predetermined time after the offer was provided to customers or a predetermined time before the spoilage time for the inventory item.

If a purchase selection is received from a customer, a transaction is completed at block 1106 to allow the customer to purchase the inventory item. Alternatively, if it is determined that a purchase selection has not been received from a customer, the offer price for the inventory item is updated by decreasing the price, as shown at block 1108. The reduced price may be determined as a function of the time since the original offer was provided to customers, time until the inventory item spoils, or other time basis. Other factors, such as likelihood of spoilage for the inventory item, may also be considered when determining the reduced price. The updated price is provided to the targeted customers, as shown at block 1110. These may be the customers who received the original offer but may also include other customers, such as customers who have newly arrived at a location within the vicinity of the inventory item.

As shown by the return from block 1110 to block 1104, after a reduced price is sent to customers, whether a purchase selection has been made by a customer is determined. The process of reducing the purchase price is continued until a purchase is made by a customer or until the spoilage time or some other related time is reached. In some embodiments, a minimum price may be set and the process of reducing the price may cease when that minimum price is reached.

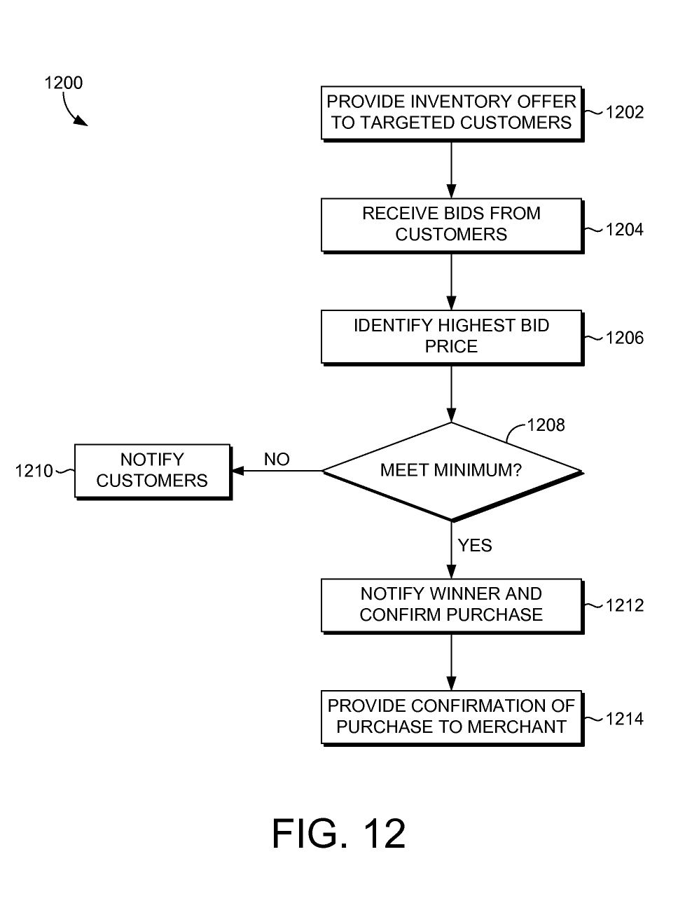

In further embodiments, when inventory items are marketed to customers, the customers may then be allowed to bid on the inventory items. Accordingly, FIG. 12 provides a flow diagram that illustrates a method 1200 for allowing customers to bid on an inventory item in accordance with an embodiment of the present invention. As shown at block 1202, an offer for an inventory item is provided to targeted customers. In response to the offer, bids are received from a number of customers during a bid period which may last, for instance, until the spoilage time for the inventory item, as shown at block 1204. Each bid includes a price that the customer who entered the bid is willing to pay for the inventory item. In some embodiments, the bid price entered by customers must meet a minimum bid price; while in other embodiments, customers may submit any bid price.

At the end of the bid period, the bid with the highest bid price is identified as shown at block 1206. In some embodiments, a minimum bid price may be set. In the embodiment shown in FIG. 12, the highest bid price must exceed a minimum bid price. As such, the highest bid price is compared to the minimum bid price to determine if it satisfies the minimum, as shown at block 1208. If not, the customers may be notified as such, as shown at block 1210, and may be able to submit new bids if desired. In some embodiments, the highest bid price may be provided to the merchant offering the inventory item, and the merchant may determine whether to accept that bid.

When a bid from a customer is accepted, the customer is notified, as shown at block 1212, and payment for the inventory item may be confirmed. Additionally, a confirmation may be provided to the merchant that the inventory item has been purchased, as shown at block 1214. The merchant may receive additional information, such as the name of the customer who purchased the item.

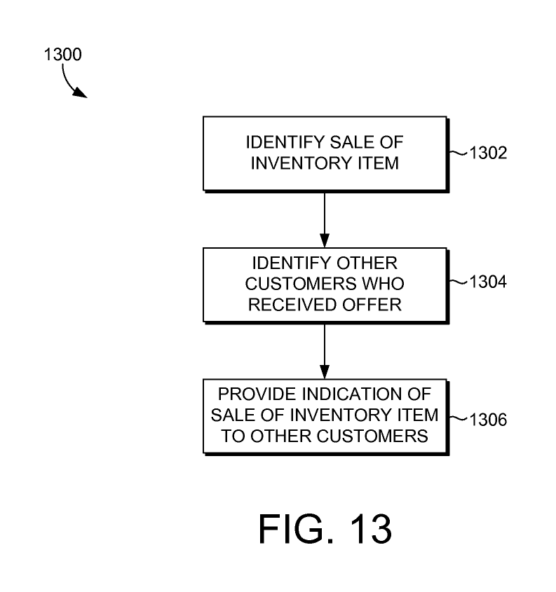

After an inventory item has been sold, other customers who received an offer for the inventory item may be informed of the sale. Turning now to FIG. 13, a flow diagram is provided that illustrates a method 1300 for notifying other users when an inventory item has been purchased in accordance with an embodiment of the present invention. As shown at block 1302, the sale of an inventory item to a particular customer is identified. The other customers who received an offer for the inventory item are identified, as shown at block 1304. An indication that the inventory item has been sold is then provided to those customers, as shown at block 1306. As such, those customers will know that the inventory item has been sold and is no longer available.

As can be understood, embodiments of the present invention provide for identifying and marketing inventory items that are likely to spoil. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform a method, the method comprising:
identifying an inventory item that is likely to spoil;
identifying a location of a customer;
determining to market the inventory item to the customer based on the location of the customer relative to a location of the inventory item; and
providing an offer for the inventory item to the customer.

2. The one or more computer storage media of claim 1, wherein the inventory item has a limited availability based on the location of the inventory item and a distinct time of availability of the inventory item that corresponds with a spoilage time of the inventory item.

3. The one or more computer storage media of claim 1, wherein identifying the inventory item comprises:
providing an interface to a merchant offering the inventory item; and
receiving information manually entered by the merchant via the interface.

4. The one or more computer storage media of claim 1, wherein identifying the inventory item comprises:
accessing an inventory management system of a merchant;
analyzing the merchant's inventory management system; and
identifying the inventory item as being likely to spoil based on analysis of the merchant's inventory management system.

5. The one or more computer storage media of claim 4, wherein analyzing the merchant's inventory management system and identifying the inventory item as being likely to spoil comprises:
accessing historical inventory information for the merchant; and
analyzing the historical inventory information for the merchant to determine a likelihood of spoilage for the inventory item.

6. The one or more computer storage media of claim 5, wherein the method further comprises determining an offer price for the inventory item based on the likelihood of spoilage for the inventory item.

7. The one or more computer storage media of claim 1, wherein the method further comprises:
identifying a second inventory item that is likely to spoil; and
determining to bundle the inventory item with the second inventory item as a package offer based on the inventory item and second inventory item complementing one another with respect to item type, location, and spoilage time,
wherein providing an offer for the inventory item to the customer comprises providing the package offer for the inventory item bundled with the second inventory item.

8. The one or more computer storage media of claim 1, wherein identifying the location of the customer comprises at least one selected from the following: accessing GPS-based location information for a mobile device of the customer; and accessing check-in information from a social networking site that tracks user check-ins at establishments.

9. The one or more computer storage media of claim 1, wherein identifying the location of the customer comprises identifying a current location of the customer, wherein the offer for the inventory item is provided to the customer at a time near to a spoilage time for the inventory item.

10. The one or more computer storage media of claim 1, wherein identifying the location of the customer comprises estimating a future location of the customer at a time around a spoilage time for the inventory item.

11. The one or more computer storage media of claim 1, wherein the method further comprises:
determining a relocation energy representing an effort for the customer to get from the location of the customer to the location of the inventory item; and
wherein determining to market the inventory item to the customer is based in part on the relocation energy.

12. The one or more computer storage media of claim 1, wherein the method further comprises:
accessing profile information for the customer that includes one or more selected from the following: demographic information, loyalty information, interests, preferences, purchase history, internet browsing history, and search history; and
wherein determining to market the inventory item to the customer is based in part on the profile information for the customer.

13. The one or more computer storage media of claim 1, wherein the method further comprises:
receiving a selection of the inventory item from the customer indicating an intent of the customer to purchase the inventory item;
confirming payment for the inventory item by the customer;
providing a confirmation to a merchant offering the inventory item that the inventory item has been purchased by the customer;
providing a confirmation to the customer that the customer has purchased the inventory item;
identifying one or more other customers who received an offer for the inventory item; and
providing an indication to the one or more other customers that the inventory item has been sold.

14. The one or more computer storage media of claim 1, wherein the method further comprises:
determining that the inventory item has not been purchased;
reducing an offer price for the inventory item to provided a reduced offer price; and
providing the reduced offer price for the inventory item to the customer.

15. The one or more computer storage media of claim 1, wherein the method further comprises:
providing an offer for the inventory item to a plurality of other customers;
receiving a first bid price from the customer and a second bid price from a first other customer;
identifying the first bid price as a highest bid price;
confirming payment for the inventory item by the customer;
providing a confirmation to a merchant offering the inventory item that the inventory item has been purchased by the customer; and
providing a confirmation to the customer that the customer has purchased the inventory item.

16. One or more computer storage media storing computer-useable instructions that, when used by one or more computing devices, cause the one or more computing devices to perform a method, the method comprising:
identifying an inventory item that is likely to spoil;
determining a location of the inventory item and a spoilage time indicative of when the inventory item will spoil if unsold;
identifying a customer within a vicinity of the inventory item near the spoilage time for the inventory item by accessing location information for the customer provided via a mobile device of the customer;
providing an offer for the inventory item to the mobile device of the customer for display to the customer; and
facilitating a purchase of the inventory item by the customer.

17. The one or more computer storage media of claim 16, wherein accessing the location information for the customer provided via the mobile device comprises accessing GPS-based location information for the mobile device.

18. The one or more computer storage media of claim 16, wherein accessing the location information for the customer provided via the mobile device comprises accessing check-in information provided, via the mobile device, to a social networking site that tracks user check-ins at establishments.

19. The one or more computer storage media of claim 16, wherein accessing the location information for the customer provided via the mobile device comprises accessing the location information directly from the mobile device.

20. An inventory marketing system including one or more computing devices having one or more processors and one or more computer storage media, the inventory marketing system comprising:
an inventory identification component that identifies inventory items that are likely to spoil and identifies a location of each inventory item and a spoilage time for each inventory item;
a customer targeting component that identifies customers to offer each inventory item, wherein the customers identified for a given inventory item are identified as being located within a vicinity of the given inventory near the spoilage time for the given inventory item;
an offer delivery component that delivers offers for each inventory item to customers identified by the customer targeting component for each inventory item; and
a transaction component that facilitates purchases of the inventory items.
